(19) United States
(12) Patent Application Publication
(10) Pub. No.: US 2024/0191055 A1
(43) Pub. Date: Jun. 13, 2024

(54) ADDITIVES AND/OR ADDITIVE-ADDITIVE COMBINATIONS FOR COMPOUNDING, THERMOPLASTIC PLASTIC COMPRISING SAME AND USE OF THE PLASTIC

(71) Applicant: MOCOM Compounds GmbH & Co. KG, Hamburg (DE)

(72) Inventors: Bjoern OTTO, Schenefeld (DE); Klaus GEBHARDT, Hamburg (DE); Christian LOSSAU, Mölln (DE)

(73) Assignee: MOCOM Compounds GmbH & Co. KG, Hamburg (DE)

(21) Appl. No.: 17/990,407

(22) PCT Filed: May 20, 2021
(86) PCT No.: PCT/EP2021/063473

§ 371 Date: Feb. 3, 2024

(30) Foreign Application Priority Data
May 20, 2020 (DE) 10 2020 113 753.2
Oct. 23, 2020 (DE) 10 2020 128 014.9

(51) Int. Cl. C08K 3/04; C08K 3/105; C08K 3/22; C08L 55/02

(52) U.S. Cl. CPC C08K 3/041; C08K 3/105; C08K 3/22; C08L 55/02; C08K 2201/001; C08K 2201/003; C08K 2201/01

(57) ABSTRACT

In order to achieve shielding in the electric and in the magnetic field of greater than 20 dB, a plastic having a compounded first magnetic additive or having two different compounded magnetic additives or having a magnetic additive and an electrically conductive additive is proposed.

The present invention relates to additives and/or additive-additive combinations for compounding in a preferably thermosoft plastic in order to impart EMC shielding properties to the plastic, wherein according to the invention not only the electric field but also the magnetic field is shielded, particularly both electric fields and magnetic fields similarly greater than 20 dB. The present invention similarly relates to a thermosoft plastic in which such additives and/or additive-additive combinations are compounded. The invention further relates to the use of such a thermosoft plastic, particularly for producing objects detectable by X-rays.

Electronic devices and apparatus typically must be designed to be electromagnetically compatible, so as not to interfere with other devices due to undesired electric or electromagnetic effects or to be interfered with by the same. Primary frequencies to be shielded against are thereby between 30 kHz and approximately 5 GHZ, wherein said range is generally referred to as high-frequency radiation. Said frequencies occur in the fields of broadcast radio; television; aircraft, ship, and police radios; GPS; UMTS; Bluetooth; and WiFi- and therefore also in mobile phones and smartphones—as well as in radar measurements and in non-destructive material testing. Said electromagnetic compatibility is often achieved by means of a housing for shielding electromagnetic interference (EMI), also particularly by a plastic housing, and thereby serves both for protecting the devices and apparatus themselves against external radiation and for protecting the surrounding area thereof against electromagnetic radiation emitted by the same.

The shielding or damping of the electromagnetic radiation is, in general, particularly difficult to implement in the magnetic field. For example, it is known in the automotive sector to use metal housings or plastic housings coated with metals in order to provide electronic components with EMI shielding. Said housings, however, are heavy and have at least disadvantages with respect to design freedom relative to plastic, making said housings not suitable for every installation situation. Metal coatings for EMI shielding are made by pressure die-casting aluminum, for example, or by PVD coating the component to be shielded, or by painting with paints comprising metal.

In general, the level of shielding achieved also depends on the wall thickness of the housing or the cladding of the device or component to be shielded, and on the wavelength range of the frequency to be shielded.

For achieving EMI shielding in plastics, it is known from the prior art, among other things, that the following materials are compounded in the following plastic matrices:
dolomite in PA or PE and granite in a styrene copolymer (EP 1 127 917 B1),
bronze or brass in PA or in a combination of PC and ABS (KR 2002 068 248 A),
steel fibers or steel fibers having an Ni—Cu coating,
CuO, CuCl₂, Cu(OH)₂ in PA (WO 2014 163 242 A1),
magnetite in PA (DE 100 08 473 A1),
silver-coated glass fibers or beads, carbon nanotubes disposed concentrically in each other (multiwall carbon nano tubes, MWCNT)—also having metal coating—(DE 10 2017 200 448 A1), and
SiC in PC and ABS (WO 2009 083 914 A1).

Said components, referred to in summary as fillers, are referred to below itemized as electrically conductive additives and as magnetic additives, wherein an electrically conductive additive has a volume resistance of less than 104 Ohm and a magnetic additive has magnetic properties.

The EMI shielding is thereby measured in an electric field based on the standards ASTM D 4935 and IEC 62153-4-4Ed2. The latter standard describes measuring the damping in the electric field in the frequency range from 30 to 3,000 MHz, and the former in the range from 30 to 1,500 MHz. The sample to be measured in the electric and magnetic field is disposed in a shielded chamber between a transmitting antenna and a receiving antenna and the electromagnetic radiation passing through the component is measured in both fields.

The object of the invention is to disclose compounds having improved shielding effect in the electric and in the magnetic field, preferably >20 dB, and thus being particularly effectively usable for EMI applications. Shielding of 20 dB corresponds to shielding of approximately 99% of electromagnetic radiation. Said level of shielding thereby relates to wall thicknesses of between 1 mm and 4 mm, preferably 2 mm, as said thicknesses include most objects made of the compounds according to the invention.

According to the invention, it was completely surprisingly found that a synergy arises from the combination of electrically conductive additives and magnetic additives in particular compounds, leading to an increase in shielding effect in the magnetic field beyond that of simple addition of the shielding effects of each additive. Surprisingly, and only in particular cases, the combination of a magnetic additive and an electrically conductive additive in a particular plastic increases the shielding effect thereof against magnetic fields and thus increases the shielding of the plastic equipped accordingly against magnetic fields. As the applicant was also able to determine, the magnetic additives found according to the invention particularly disproportionately shield not only the electric field but also the magnetic field as a function of the type of magnetism of each, and especially of the particle size thereof (D50 value), as well as in combination with electrically conductive additives, when compounded in one of the thermosoft plastics according to the invention. The applicant surprisingly determined that the combination of two magnetic additives also leads to synergistically increased shielding in the magnetic field beyond that of simple addition.

The invention greatly advantageously enables the use of compounds having corresponding, easily commercially available additives added thereto, referred to in summary as fillers, particularly as fillers for the plastic matrix, in order to surprisingly achieve particularly high magnetic shielding in a simple manner. Plastic housings produced from compounds according to the invention have the advantage, in comparison with metal housings or metal-coated housings, of having reduced weight, as is of great significance particularly for use in e-mobility. In addition, said compounds provide a high degree of freedom for the physical design of the shape of the components produced therefrom and thus high adaptability to a wide range of installation and use conditions.

The plastics suitable for use according to the invention due to the inner structure thereof and the physical and chemical properties thereof include particularly amorphous plastics such as PC, ABS, and PC-ABS combinations, and/or partially crystalline plastics, preferably PA, PA6, PA66, and PA610, but also PPS. Base plastics not optimized for an EMI application can thus greatly advantageously be used for compounding the filler according to the invention, and can be enhanced for the EMI application by means of compounding said additives, so that superlatively EMI-shielded components can be produced from the plastics according to the invention.

The additive combinations according to the invention include carbon fibers (CF) combined with magnetic additives.

According to the invention, a single ferromagnetic additive-particularly 325 mesh powdered iron— can also improve the magnetic shielding at an extremely high and technically not easily achievable weight proportion of 70-80 wt % of the entire compound of filler and base plastic or plastic matrix.

In a further embodiment of the invention, a synergy of the combination of an electrically conductive additive and a magnetic additive was able to be achieved for the following combinations:
15% CF+40% natural magnetite, particle density 5.2 g/cm³, ≥98.1% magnetite content, D50=17 μm in PC+ABS
15% CF+60% 325 mesh powdered iron in PA6.

For said combinations, a higher shielding in the magnetic field was surprisingly achieved than for each individual additive.

Also surprising is the high shielding effect according to the invention-particularly for the magnetic field for PPS to which 80% ferromagnetic 325 mesh powdered iron has been added.

The same applies for the polyamide PA66 having a 1:1 admixture of paramagnetic aluminum silicate and ferrimagnetic ferroaluminoceladonite, the latter being a special type of mica. Shielding of up to >25 dB in the magnetic field was achieved by means of said filler combination.

PPS and PA66 also achieve a surprisingly high EMI shielding behavior at the admixture indicated above of additives according to the invention.

According to the invention, compounding of 80% and 70% respectively of ferromagnetic 325 mesh powdered iron in PC+ABS and PA6 also achieved shielding values in both fields of >>20 dB (and of >20 dB for 70%). It is thereby particularly preferable according to the invention if powdered iron having a particle size of D50≤ 45 μm is compounded.

According to the invention, the compounding of 5% Ag—Cu-20 (D50: 8-13 μm, diamagnetic flaky copper particles having 20% diamagnetic silver coating) and 33.33% Plasticyl PC1501 (5% pure diamagnetic MWCNT content) in PC+ABS also leads to a synergistic effect of the MWCNTs on the magnetic field of the flaky copper particles Ag—Cu-20, having an increased shielding effect against the magnetic field in comparison with the individual additives. Said material is known from DE 10 2017 209 357.9, the content thereof hereby being explicitly incorporated by reference in the disclosure content of the present patent application.

All other combinations according to the invention of electrically conductive additives and magnetic additives led to shielding in the electric and magnetic field of greater than 20 dB in each case—that is, EMI shielding—but no synergistic increase in shielding of the magnetic field was evident. In other words, the values of shielding against the electric field correspond to the shielding effect of the electrically conductive additive and the values of shielding against the magnetic field correspond to the shielding effect of the magnetic additive.

The applicant has found that the D50 value relating to the particle diameter of the magnetic additive to be used is a deciding parameter for the suitability thereof for synergistic shielding. Therefore, the D50 value of the magnetic additive is specifically selected according to the invention for influencing the shielding effect in the magnetic field in order to cause said additive to be according to the invention.

In a further advantageous embodiment of the invention, PA and PPS are each used as the matrix plastic to which the additives are added as fillers. Here the combined addition of carbon fibers and magnetite has been found to be particularly effective at shielding according to the invention.

In PA as the plastic, the combined addition of carbon fibers and powdered iron and/or of carbon fibers and magnetite has been found to be particularly effective at shielding according to the invention. In PPS as the matrix plastic, an addition of 80% and 70% of ferromagnetic 325 mesh powdered iron without adding carbon fibers is according to the invention, whereas the combination of carbon fibers and gas-atomized ferritic powdered steel is surprisingly not particularly effective at shielding.

In this context, it is particularly advantageous if the additives having a D50 value≤45 μm are used for PA6 as the plastic.

The magnetic additives suitable according to the invention come from the range of diamagnets, paramagnets, ferro- and ferrimagnets having high magnetic susceptibility (χ 500-3,000), up to partially very high magnetic susceptibility (×10,000-50,000). Particularly the following magnetic additives can be considered in the context of the invention, wherein the value of the magnetic susceptibility χ is indicated after the magnetic additive in each case:

Type of magnetism

| Superparamagnetic | Ferromagnetic | Potential |
|---|---|---|
| Nanomagnetite | Hematite/maghemite | Indium, indium oxide |
| (biocompatible) | (χ = 760-50,000) | |
| Nanohematite | Iron | Titanium boride |
| (biocompatible) | (χ = 50,000) | |
| Copper(II) oxide | Pyrrhotite | Brass |
| nanocrystals | (χ = 69,000) | |
| Peridotite | Gadolinium | Bronze |
| (χ = 6,600) | | |
| | Copper-nickel | Gallium phosphide |
| | (constantan) | |
| | | Silicon carbide/fiber |
| | | nano-silicon carbide |
| | | Cu(I) oxide |
| | | Phosphate flame retardant |

Paramagnetic

| | | | |
|---|---|---|---|
| Manganese bismutite | Dolomite | Siderite | Granulite |
| | (χ = 41) | (χ = 270) | (χ = 1,000) |
| Copper(II) oxide | Ilmenite | Nickel sulfate | Granite |
| acetate/hydroxide/ | (χ = 80) | (χ = 416) | (χ = 1,900) |
| chloride | | | |
| Gallium arsenide | Fayalite | Wolframite/ | Manganese |
| (intrinsic | (χ = 130) | tungsten | sulfate |
| semiconductor) | | | (χ = 2,640) |
| Gallium chloride | Quartzite | Jacobsite | Serpentinite |
| (semiconductor) | (χ = 170) | (χ = 500) | (χ = 2,900) |
| Aluminum (χ 22) | Copper | Serpentine | |
| | sulfate | (χ = 630) | |
| | (χ = 176) | | |

A thermosoft plastic according to the invention having compounded filler in the form of a magnetic additive and/or having compounded filler in the form of a combination of magnetic additive and electrically conductive additive is advantageously suitable and usable for achieving X-ray detectability of products made therefrom.

The following magnetic additives are particularly suitable in the context of the invention, the admixture proportion, optionally the preferred admixture proportion, the D50 value thereof, and the type of magnetism thereof being indicated for each:

1) Manganese sulfate 15-25% D50: n.a., paramagnetic
2) CuSn10 having indeterminate particle shape 0-25% D50:
64.4 μm, diamagnetic copper alloy
3) CuZn30 having indeterminate particle shape 0-25% D50:
240 mesh, diamagnetic copper alloy
4) Copper(II) oxide 0-50%, preferably 15-45% D50: 23.9 μm,
diamagnetic ceramic and semiconductor
5) 325 mesh powdered iron 15-85%, preferably 55-85%
D50: ≤45μm, ferromagnetic
6) gas-atomized ferritic powdered steel 15-85%, preferably
55-85% D50: 20-53 μm, ferrimagnetic
7) natural magnetite (iron oxide/iron ore) 15-65%
particle density 5.2 g/cm³, ≥98.1% magnetite content D50:
17 μm, ferrimagnetic
8) aluminum oxide (aluminum ceramic) 65-75%, Al2O₃
content >99.5%, D50: 1.6 μm, paramagnetic
9) anhydrous aluminum silicate treated with aminosilane
(aluminum ore), 35-45% Al2O3 content 42.1-44.3%, SiO2
content 51.0-52.4%, TiO2 content 1.56-2.5% D50: 1.4 μm,
paramagnetic
10) dolomite (calcium magnesium ore) 35-45% D50: 2.4-3.0
μm, whiteness Ry ≥93.5% paramagnetic
11) aluminum silicate + ferroaluminoceladonite (iron ore)
each 10-20%; see above + MICA, D50: 4.2 μm, ferrimagnetic
12) Ag—Cu-20 (flaky copper particles with 20% silvercoating) 5-10%,
D50: 8-13 μm, diamagnetic + PlasticylPC1501 (2-5% pure
diamagnetic MWCNT portion) 13.33-33.33%

The following combinations of magnetic additives and electrically conductive additives are particularly well suited in the context of the invention, wherein the electrically conductive additive in each case is carbon fiber at a weight proportion between 10 wt % and 20 wt %, and the magnetic additive is:
magnetite at a weight proportion between 35 wt % and 65 wt %, a particle density of 5.2 g/cm3, a magnetite content of ≥98.1% and a D50 value of 17 μm, or
325 mesh powdered iron at a weight proportion between 55 wt % and 65 wt % and a D50 value of ≤45 μm, or
gas-atomized ferritic powdered steel at a weight proportion between 55 wt % and 65 wt %, a D50 value of 20-60 μm, or
manganese zinc ferrite at a weight proportion between 35 wt % and 65 wt % and a D50 value of 250-315 μm.

In the context of the invention, the particle size of the magnetic additives and/or electrically conductive additives, indicated as the D50 value, is preferably 10-60 μm and/or 250-315 μm for ferrimagnetic additives, ≤45 μm for ferromagnetic additives, in order to achieve ideal shielding of the magnetic field and <3 μm for paramagnetic additives in order to achieve ideal shielding of the magnetic field. Aluminum oxide, dolomite, aluminum silicate, ferroaluminoceladonite are particularly selected in said size range according to the invention. The size of the particles of the paramagnetic additives according to the invention is alternatively 10-20 μm.

For diamagnetic additives, ideal shielding behavior in the magnetic field can be achieved in the context of the invention at a D50 value of 8-13 μm (D50 value of Ag—Cu-20, 20% silver coating on flaky copper particles) in combination with multi-walled carbon nanotubes (MWCNT).

For further diamagnetic additives in combination with carbon fibers in the context of the invention, the particle size is preferably in the interval between 8-13 μm in order to achieve optimum shielding in both fields.

According to the invention, the particle size of the magnetic additives in general is selected in the interval from 10-60 μm in order to achieve particularly high shielding in the magnetic field and simultaneously very good distribution of the additives in the plastic matrix.

As has been shown by the embodiment examples listed below in tabular form in Table 2a, the use of other particle sizes did not lead to the synergy according to the invention.

The components produced from the plastics for which the EMI measurement was performed have a component thickness between 1 mm and 4 mm, preferably between 2 mm and 3 mm.

The plastics according to the invention can be used advantageously in order to make objects made thereof or coated with the same suitable for X-ray detection. The objects produced from or coated with the plastics according to the invention are thus advantageously detectable by means of a portable X-ray device or by means of a conventional X-ray device in medical practices.

For the present use according to the invention for detectability by means of X-ray radiation, the following magnetic additives are preferred:
1) CuSn10 having indeterminate particle shape at a D50 value of 64.4 μm at or above a weight proportion of 20 wt %,
2) 240 mesh CuZn30 having indeterminate particle shape, at or above a weight proportion of 20 wt %,
3) copper(II) oxide at a D50 value of 23.9 μm, at or above a weight proportion of 20 wt %,
4) natural magnetite having a particle density of 5.2 g/cm3, a magnetite content of ≥ 98.1%, a D50 value of 17 μm, at a weight proportion between 20 wt % and 40 wt %,
5) 325 mesh powdered iron at a weight proportion between 20 wt % and 40 wt %.
6) gas-atomized ferritic powdered steel at a weight proportion between 55 wt % and 80 wt % and a D50 value of 20-53 μm.

### EMBODIMENT EXAMPLES

The invention is described below in tables using preferred embodiment examples. Material compositions of the plastics used as the base matrix and the compounded magnetic additives and electrically conductive additives are thereby listed in the tables, and advantageous properties of each composition are listed in each case.

Each of the embodiment examples listed in the table below comprises the base or matrix plastic used, the type of filler or the additive mixture, the D50 value of the particle size, and the weight proportions of the compounded magnetic additives and electrically conductive additives, as well as the proportions of each. Sample objects having a wall thickness of 2 mm were produced from said compounds made of matrix plastic and filler. Measuring the shielding against the electric and against the magnetic field was fundamentally performed on said 2 mm thick sample objects made of the corresponding plastics, as said thickness is closest to the majority of frequently typical housing applications. Said testing further takes place near the sample.

### Base Recipes

Base recipe 1 is a PC-ABS having a weight of 100,600 g.

| Base recipe 1 | Weight [g] |
|---|---|
| High-impact ABS | 48,000 |
| Low-viscosity PC | 52,000 |
| Lubricant | 200 |
| Processing aids | 400 |

Base recipe 2 is also a PC-ABS having a weight of 100,100 g, wherein lubricant is already present in the matrix plastic:

| Base recipe 2 | Weight [g] |
|---|---|
| PC-ABS 65:35 | 100,000 |
| Antioxidant | 100 |

Base recipe 3 is a PA6 having a weight of 101,800 g and the following composition:

| Base recipe 3 | Weight [g] |
|---|---|
| PA6 Type A (2.4 = NV) | 100,000 |
| Lubricant | 800 |
| Antioxidant | 1,000 |

Base recipe 4 is a PA66 having the following composition; base recipe 4a is a PA66 having a weight of 102,000 g; and base recipe 4b is a PA66 having a weight of 104,242 g:

| Base recipe 4 | Proportion |
|---|---|
| PA66 TYPE A (2.9 = MV) | 22.9% |
| Antioxidant | 0.5% |
| Lubricant | 0.3% |
| | Weight [g] |
| Base recipe 4a | |
| PA66 Type A (2.9 = MV) | 100,000 |
| Lubricant | 300 |
| Antioxidant | 500 |
| Lamp black batch (50%) | 1,200 |
| Base recipe 4b | |
| PA66 Type A (2.9 = MV) | 70,000 |
| PA6 | 30,000 |
| Lubricant | 300 |
| Antioxidant | 1,800 |
| Colorant | 2,142 |

Base recipe 5 is a PA6 having the following composition:

| Base recipe 5 | Proportion |
|---|---|
| PA6 Type A (2.9 = MV) | 54.7% |
| Antioxidant | 0.5% |
| Lubricant | 0.3% |
| Colorant | 1.0% |

Base recipes 6 and 6a are each a PA6:

| | Weight [g] |
|---|---|
| Base recipe 6 | |
| PA6 Type A (2.4 = NV) | 100,000 |
| Inherent filler | 20,760 |
| Lubricant | 500 |
| Antioxidant | 500 |
| Colorant | 2,800 |
| Base recipe 6a | |
| PA6 Type A (2.4 = NV) | 100,000 |
| Lubricant | 500 |
| Antioxidant | 500 |
| Colorant | 2,800 |

Base recipe 7 is a PPS having a weight of 100,900 g; base recipe 7a is a PPS having a weight of 101,896 g:

| | Weight [g] |
|---|---|
| Base recipe 7 | |
| PPS (VISKO 50) | 100,000 |
| Lubricant | 600 |
| Colorant | 300 |
| Base recipe 7a | |
| PPS | 100,000 |
| Lubricant | 610 |
| Colorant | 1,286 |

The magnetic and electrically conductive additives used are particularly the following:

Magnetite has the composition Fe3O₄ ═Fe(II)Fe(III)2O4 and a spinel structure and ferrimagnetic behavior.

Powdered iron is ferromagnetic.

MnZn ferrite has the composition MnaZn(1−a)Fe2O4.

Powdered steel is a gas-atomized ferritic powder having 20-53 μm particle size and is ferrimagnetic.

Plasticyl PC1501 is a 15% MWCNT; CuSn10 is a diamagnetic, silver-coated copper.

Ultrafine aluminum oxide Al₂O₃ is paramagnetic; aluminum silicate Al₂O₃SiO₂ is paramagnetic.

Mica is a ferrimagnetic ferroaluminoceladonite K Al(Mg, Fe) [Si₄O₁₀(OH)₂].

Dolomite CaMg(CO₃)₂ is paramagnetic.

AgCu20 is diamagnetic, flaky copper particles having 20% silver coating and a D50 value of 8-13 μm.

Carbon fabric is a preform made of industrial waste having a networked structure.

Manganese sulfate MnSO₄ is paramagnetic.

Copper(II) oxide CuO having a D50 value of 23.9 μm is a diamagnetic ceramic and a semiconductor.

TABLE 1
Base recipe 1, magnetic additive

| | | 2 | | |
|---|---|---|---|---|
| | 1 | Bronze | 3 | 4 |
| | MnSO₄ | (CuSn10) | Cu(II)O | Cu(II)O |
| Weight [g] | 25150 | 25150 | 25150 | 67065 |
| Mixture proportion | 20 | 20 | 20 | 40 |
| [%] | | | | |
| Shielding [dB] | | | | |
| H-50 MHz | 17.05 | 16.79 | 14.15 | 15.86 |
| H 500 MHz | 16.70 | 16.53 | 15.87 | 15.98 |
| H 1000 MHz | 21.19 | 21.34 | 23.44 | 20.31 |
| E 50 MHz | 13.45 | 14.04 | 13.28 | 12.17 |
| E 500 MHz | 12.46 | 13.44 | 12.77 | 11.82 |
| E 1000 MHz | 12.09 | 17.80 | 21.98 | 33.59 |
| Surface resistance - | n.d. | 3.0E12 | 4.0E+09 | 2.0E+14 |
| ring electrode [ohm] | | | | |
| Specific volume | n.d. | n.d. | 7.0E+14 | n.d. |
| resistance [ohm*cm] | | | | |
| Residue on ignition [%] | 18.0 | 35.0 | 30.4 | 48.7 |
| X-ray detection on 1 cm | limited | yes | yes | yes |
| thick pork | | | | |
| Particle size D50 | n.a | 64.4 | 23.9 | 23.9 |
| [μm] | | | | |

TABLE 2
Base recipe 1, electrically conductive additive and magnetic additive

| | 5 | 6 | 7 | 8 | 9 | 10 |
|---|---|---|---|---|---|---|
| | CF + | CF + | SF + | Powdered | Powdered | Powdered |
| | magnetite | magnetite | magnetite | iron | iron | iron |
| Weight [g] | 20120 + 80480 | 33533 + 89422 | 28733 + 86222 | 25150 | 67067 | 150900 |
| Mixture proportion [%] | 10 + 40 | 15 + 40 | 10 + 40 | 20 | 40 | 60 |
| Shielding [dB] | | | | | | |
| H-50 MHz | 14.26 | 15.60 | 15.31 | 15.02 | 15.76 | 16.02 |
| H 500 MHz | 14.67 | 16.76 | 14.76 | 14.59 | 14.53 | 15.03 |
| H 1000 MHz | 18.44 | 21.68 | 16.69 | 17.31 | 15.70 | 20.37 |
| H 1500 MHz | 20.01 | 26.69 | 18.23 | 18.57 | 18.58 | 18.09 |
| H 2000 MHz | 29.88 | 32.54 | 18.87 | 18.43 | 17.47 | 17.35 |
| H 2500 MHz | 27.59 | 41.22 | 20.20 | 20.70 | 21.83 | 20.71 |
| H 3000 MHz | 33.47 | 45.77 | 22.31 | 23.52 | 24.32 | 23.31 |
| E 50 MHz | 33.67 | 26.60 | 21.86 | 15.34 | 14.59 | 12.73 |
| E 500 MHz | 43.12 | 43.91 | 23.54 | 14.80 | 14.46 | 13.61 |
| E 1000 MHz | 39.06 | 43.92 | 32.23 | 17.09 | 16.86 | 22.67 |
| E 1500 MHz | 35.45 | 40.34 | 17.20 | 12.11 | 11.73 | 10.51 |
| E 2000 MHz | 36.4 | 44.00 | 19.18 | 11.57 | 11.19 | 10.51 |
| E 2500 MHz | 47.51 | 55.64 | 17.11 | 11.70 | 11.86 | 10.68 |
| E 3000 MHz | 46.42 | 53.39 | 15.89 | 13.66 | 11.66 | 10.40 |
| Surface resistance- | 16 | 10 | 430 | 1.0E+12 | 1.0E+12 | 8.0E+12 |
| ring electrode [ohm] | | | | | | |
| Specific volume | 24192 | 1586 | 102000 | 2.0E+14 | 4.0E+14 | 6.0E+14 |
| resistance [ohm*cm] | | | | | | |
| Residue on ignition | 40.4 | 40.7 | 53.7 | 27.3 | 55.0 | 77.7 |
| [%] | | | | | | |
| X-ray detection on 1 | yes | — | yes | limited | yes | — |
| cm thick pork | | | | | | |
| Particle size D50 [μm] | 10-20 | 10-20 | 10-20 | <45 | <45 | <45 |

Where: CF = carbon fiber 7 μm, 6 mm length, SF = steel fiber (75%) 11 μm, 5 mm length, 325 mesh powdered iron

TABLE 2a
Base recipes and additive(s), not according to the invention:

| | Base | Base | Base |
|---|---|---|---|
| | recipe 1 | recipe 1 | recipe 7 |
| | 6a | 15a | 30 |
| | CF + | CF + MnZn | Powdered |
| | magnetite | ferrite | steel + CF |
| | 5 μm | 8 μm | 20-53 μm |
| Weight [g] | 33533 + | 33533 + | 241440 + |
| | 89422 | 89422 | 60360 |
| Mixture proportion | 15 + 40 | 15 + 40 | 60 + 15 |
| [%] | | | |
| Shielding [dB] | | | |
| H-50 MHz | 16.3 | 17.6 | 1.8 |
| H 500 MHz | 13.4 | 14.5 | 5.3 |
| H 1000 MHz | 12.7 | 13.3 | 4.3 |
| H 1500 MHz | 13.0 | 13.1 | 6. |
| H 2000 MHz | 14.6 | 12.7 | 7.8 |
| H 2500 MHz | 13.9 | 11.2 | 8.0 |
| H 3000 MHz | 14.0 | 8.7 | 8.9 |
| E 50 MHz | 25.7 | 25.4 | 14.6 |
| E 500 MHz | 39.9 | 32.3 | 32.2 |
| E 1000 MHz | 37.2 | 29.8 | 29.5 |
| E 1500 MHz | 34.5 | 28.3 | 31.5 |
| E 2000 MHz | 37.5 | 31.8 | 31.5 |
| E 2500 MHz | 47.4 | 30.1 | 38.9 |
| E 3000 MHz | 45.3 | 30.3 | 47.4 |
| Surface resistance - | 20 | 23 | 3 |
| ring electrode [ohm] | | | |
| Specific volume | 1.344 | 1.408 | 4 |
| resistance [ohm*cm] | | | |
| Residue on ignition | 52.6 | 50.6 | 85.7 |
| [%] | | | |
| X-ray detection on 1 cm | | | |
| thick pork | | | |
| Particle size D50 | | | |
| [μm] | | | |

TABLE 3
Base recipe 1, electrically conductive additive and magnetic additive

| | 11 | 12 | 13 | 14 | 15 | 16 | 17 |
|---|---|---|---|---|---|---|---|
| | Powdered | CF + powdered | Mag- | Mag- | CF + MnZn | CF + MnZn | CF + |
| | iron | iron | netite | netite | ferrite | ferrite | magnetite |
| Weight [g] | 402400 | 60360 + 241440 | 25150 | 150900 | 33533 + 89422 | 60360 + 241440 | 60360 + 241440 |
| Mixture | 80 | 15 + 60 | 20 | 60 | 15 + 40 | 15 + 60 | 15 + 60 |
| proportion [%] | | | | | | | |
| Shielding [dB] | | | | | | | |
| H-50 MHz | 35.7 | 17.09 | 17.04 | 15.17 | 19.79 | 20.82 | 20.31 |
| H 500 MHz | 51.7 | 14.69 | 16.01 | 15.22 | 19.11 | 19.2 | 19.22 |
| H 1000 MHz | 44.5 | 19.14 | 20.62 | 20.18 | 20.28 | 25.88 | 23.93 |
| H 1500 MHz | 39.2 | 18.02 | | | | | |
| H 2000 MHz | 31.3 | 21.79 | | | | | |
| H 2500 MHz | 35.6 | 21.43 | | | | | |
| H 3000 MHz | 24.8 | 25.03 | | | | | |
| E 50 MHz | 26.4 | 26.79 | 14.30 | 13.99 | 24.01 | 21.70 | 25.52 |
| E 500 MHz | 49.1 | 35.59 | 14.02 | 14.82 | 26.80 | 23.01 | 43.25 |
| E 1000 MHz | 50.0 | 37.48 | 22.64 | 28.77 | 30.50 | 26.51 | 37.80 |
| E 1500 MHz | 47.2 | 27.14 | | | | | |
| E 2000 MHz | 45.6 | 29.29 | | | | | |
| E 2500 MHz | 46.8 | 29.96 | | | | | |
| E 3000 MHz | 49.6 | 29.17 | | | | | |
| Surface | 3 | 40 | 7.0E+13 | 5.0E+11 | 141 | 117 | 17 |
| resistance-ring | | | | | | | |
| electrode [ohm] | | | | | | | |
| Specific volume | 340 | 192 | 5.0E+13 | 4.0E+09 | 1572 | 2386 | 126 |
| resistance | | | | | | | |
| [ohm*cm] | | | | | | | |
| Residue on | 101.13 | 80.2 | 21 | 61.1 | 38.9 | 59.1 | 51.7 |
| ignition [%] | | | | | | | |
| TGA C-fiber/ | | 12.7 | | | 13.4 | 13.7 | 12.9 |
| graphite content | | | | | | | |
| Particle size D50 | <45 | <45 | 10-20 | 10-20 | 250-315 | 250-315 | 10-20 |
| [μm] | | | | | | | |
| Density [g/cm³] | 3.425 | 2.52 | 1.31 | 2.09 | 1.76 | 2.34 | 1.98 |

TABLE 4
Base recipe 2 with electrically conductive
additive and magnetic additive

| | 18 |
|---|---|
| | AgCu20 + MWCNT |
| Weight [g] | 8114 + 54099 |
| Mixture proportion | 5 + 33.3 |
| [%] | |
| Shielding [dB] | |
| H-50 MHz | 16.80 |
| H 500 MHz | 16.43 |
| H 1000 MHz | 23.21 |
| H 1500 MHz | |
| H 2000 MHz | |
| H 2500 MHz | |
| H 3000 MHz | |
| E 50 MHz | 30.60 |
| E 500 MHz | 37.17 |
| E 1000 MHz | 33.60 |
| E 1500 MHz | |
| E 2000 MHz | |
| E 2500 MHz | |
| E 3000 MHz | |
| Surface resistance - | 1667 |
| ring electrode [ohm] | |
| Specific volume | 14600000 |
| resistance [ohm*cm] | |
| Density [g/cm³] | 1.219 |
| Residue on ignition | 5.4 |
| [%] | |
| Particle size D50 | 8-13 |
| [μm] | |

TABLE 5
Base recipe 3 with electrically conductive
additive and magnetic additive

| | 19 | | |
|---|---|---|---|
| | CF + | 20 | 21 |
| | powdered | Powdered | Powdered |
| | iron | iron | iron |
| Weight [g] | 61079 + 244315 | 237533 | 402400 |
| Mixture proportion | 15 + 60 | 70 | 80 |
| [%] | | | |
| Shielding [dB] | | | |
| H-50 MHz | 16.52 | 24.97 | 40.11 |
| H 500 MHz | 19.38 | 24.08 | 49.05 |
| H 1000 MHz | 22.93 | 23.51 | 38.22 |
| H 1500 MHz | 29.38 | 21.96 | 38.31 |
| H 2000 MHz | 29.07 | 25.08 | 31.84 |
| H 2500 MHz | 27.86 | 19.86 | 26.72 |
| H 3000 MHz | 24.16 | 21.16 | 30.81 |
| E 50 MHz | 20.07 | 25.91 | 25.83 |
| E 500 MHz | 36.55 | 35.84 | 43.38 |
| E 1000 MHz | 35.64 | 32.93 | 47.56 |
| E 1500 MHz | 34.51 | 33.61 | 45.10 |
| E 2000 MHz | 36.47 | 34.84 | 42.40 |
| E 2500 MHz | 37.45 | 32.65 | 37.25 |
| E 3000 MHz | 45.08 | 33.73 | 35.50 |
| Surface resistance - | 4 | 130 | 18 |
| ring electrode [ohm] | | | |
| Specific volume | 384 | 520 | 19 |
| resistance [ohm*cm] | | | |
| Residue on ignition [%] | 80.2 | 80.4 | 91.7 |
| Carbon fiber content [%] | | — | — |
| Particle size D50 | <45 | <45 | <45 |
| [μm] | | | |
| Density [g/cm³] | 2.584 | 2.75 | 3.46 |

TABLE 6
Base recipe 4 and base recipe 4a

| | 22 | | 23 | | 24 |
|---|---|---|---|---|---|
| Base recipe 4 | Carbon | Base recipe 4a | Alμminum | Base recipe 4b | Alμminμm |
| | fabric + | | silicate | | silicate + |
| | conductive | | | | mica |
| | carbon | | | | |
| | black | | | | |
| | | Weight [g] | 68,000 | Weight [g] | 22221 + 22221 |
| Mixture proportion | 16 + 60 | Mixture | 40 | Mixture proportion | 15 + 15 |
| [%] | | proportion [%] | | [%] | |
| Shielding [dB] | | Shielding [dB] | | Shielding [dB] | |
| | 17.49 | H-50 MHz | 21.27 | H-50 MHz | 19.50 |
| H 500 MHz | 19.07 | H 500 MHz | 21.88 | H 500 MHz | 19.98 |
| H 1000 MHz | 23.93 | H 1000 MHz | 22.27 | H 1000 MHz | 25.94 |
| H 1500 MHz | | H 1500 MHz | | H 1500 MHz | |
| H 2000 MHz | | H 2000 MHz | | H 2000 MHz | |
| H 2500 MHz | | H 2500 MHz | | H 2500 MHz | |
| H 3000 MHz | | H 3000 MHz | | H 3000 MHz | |
| E 50 MHz | 27.38 | E 50 MHz | 15.35 | E 50 MHz | 15.99 |
| E 500 MHz | 42.53 | E 500 MHz | 15.31 | E 500 MHz | 15.96 |
| E 1000 MHz | 52.19 | E 1000 MHz | 25.01 | E 1000 MHz | 25.70 |
| E 1500 MHz | | E 1500 MHz | | E 1500 MHz | |
| E 2000 MHz | | E 2000 MHz | | E 2000 MHz | |
| E 2500 MHz | | E 2500 MHz | | E 2500 MHz | |
| E 3000 MHz | | E 3000 MHz | | E 3000 MHz | |
| Surface | | Surface | | Surface | |
| resistance-ring | | resistance-ring | | resistance-ring | |
| electrode [ohm] | | electrode [ohm] | | electrode [ohm] | |
| Specific volume | | Specific volume | | Specific volume | |
| resistance | | resistance | | resistance | |
| [ohm*cm] | | [ohm*cm] | | [ohm*cm] | |
| Residue on | | Residue on | 38.3 | Residue on | 29.9 |
| ignition [%] | | ignition [%] | | ignition [%] | |
| Particle size D50 | 1.4 | Particle size D50 | 1.4 | Particle size D50 | 1.4 + 4.2 |
| [μm] | | [μm] | | [μm] | |

TABLE 6
Base recipe 5 with electrically conductive additive

| | 25 |
|---|---|
| | Carbon fabric |
| Mixture proportion | 43.5 |
| [%] | |
| Shielding [dB] | |
| H-50 MHz | 16.34 |
| H 500 MHz | 25.37 |
| H 1000 MHz | 34.33 |
| H 1500 MHz | |
| H 2000 MHz | |
| H 2500 MHz | |
| H 3000 MHz | |
| E 50 MHz | 23.40 |
| E 500 MHz | 44.81 |
| E 1000 MHz | 42.63 |
| E 1500 MHz | |
| E 2000 MHz | |
| E 2500 MHz | |
| E 3000 MHz | |
| Surface resistance - | |
| ring electrode [ohm] | |
| Specific volume | |
| resistance [ohm*cm] | |
| Residue on ignition [%] | |
| Carbon fiber content [%] | |
| Particle size D50 | |
| [μm] | |
| Density [g/cm³] | |

TABLE 7
Base recipe 6 with magnetic additive and
base recipe 6a with magnetic additive

| | 26 | | 27 |
|---|---|---|---|
| | Al₂O₃ | | Al₂O₃ |
| Weight [g] | 290640 | Weight [g] | 242200 |
| Mixture proportion | 75 | Mixture proportion | 70 |
| [%] | | [%] | |
| Shielding [dB] | | Shielding [dB] | |
| H-50 MHz | 15.11 | H-50 MHz | 16.32 |
| H 500 MHz | 15.55 | H 500 MHz | 16.67 |
| H 1000 MHz | 20.71 | H 1000 MHz | 20.27 |
| H 1500 MHz | | H 1500 MHz | |
| H 2000 MHz | | H 2000 MHz | |
| H 2500 MHz | | H 2500 MHz | |
| H 3000 MHz | | H 3000 MHz | |
| E 50 MHz | 13.12 | E 50 MHz | 13.83 |
| E 500 MHz | 12.93 | E 500 MHz | 13.72 |
| E 1000 MHz | 17.77 | E 1000 MHz | 18.33 |
| E 1500 MHz | | E 1500 MHz | |
| E 2000 MHz | | E 2000 MHz | |
| E 2500 MHz | | E 2500 MHz | |
| E 3000 MHz | | E 3000 MHz | |
| Surface resistance - | | Surface resistance - | |
| ring electrode [ohm] | | ring electrode [ohm] | |
| Specific volume | | Specific volume | |
| resistance [ohm*cm] | | resistance [ohm*cm] | |
| Residue on ignition | 74.2 | Residue on ignition | 69.6 |
| [%] | | [%] | |
| Particle size D50 | 1.6 | Particle size D50 | 1.6 |
| [μm] | | [μm] | |

TABLE 8
Base recipe 7 with magnetic additive and
base recipe 7a with magnetic additive

| | 28 | | |
|---|---|---|---|
| | Powdered | | 29 |
| | iron | | Dolomite |
| Weight [g] | 403,600 | Weight [g] | 102,000 |
| Mixture proportion | 80 | Mixture proportion | 50 |
| [%] | | [%] | |
| Shielding [dB] | | Shielding [dB] | |
| H-50 MHz | 22.90 | H-50 MHz | 15.29 |
| H 500 MHz | 37.97 | H 500 MHz | 15.26 |
| H 1000 MHz | 46.72 | H 1000 MHz | 20.07 |
| H 1500 MHz | | H 1500 MHz | |
| H 2000 MHz | | H 2000 MHz | |
| H 2500 MHz | | H 2500 MHz | |
| H 3000 MHz | | H 3000 MHz | |
| E 50 MHz | 27.82 | E 50 MHz | 14.94 |
| E 500 MHz | 49.55 | E 500 MHz | 14.62 |
| E 1000 MHz | 42.18 | E 1000 MHz | 18.94 |
| E 1500 MHz | | E 1500 MHz | |
| E 2000 MHz | | E 2000 MHz | |
| E 2500 MHz | | E 2500 MHz | |
| E 3000 MHz | | E 3000 MHz | |
| Surface resistance - | | Surface resistance - | |
| ring electrode [ohm] | | ring electrode [ohm] | |
| Specific volume | | Specific volume | |
| resistance [ohm*cm] | | resistance [ohm*cm] | |
| Residue on ignition | 79.1 | Residue on ignition | 49.4 |
| [%] | | [%] | |
| Particle size D50 | <45 | Particle size D50 | <3 |
| [μm] | | [μm] | |

In addition to the embodiment examples according to the invention listed in the tables, Table 2a uses embodiment examples not according to the invention to show the significance of particle size. The comparison between magnetite having a particle size according to the invention and particle size not according to the invention, with parameters otherwise unchanged, and the corresponding comparison to ferrite, show that too small a particle size leads to a reduction in the shielding effect in the magnetic field (H field) and thus to compounds not according to the invention. The table also shows that powdered iron is not simply interchangeable with an iron alloy, but rather that the type of magnetic additive shows a great influence on the shielding behavior.

It is further evident that the shielding in the E field drops when the additive particles are too large, as can be seen particularly in comparing magnetite to MnZn ferrite. This is potentially due to interference in the network of carbon fibers by fibers penetrating due to the size and mass thereof.

It is further evident that there is no correlation between the shielding in the E field and H field and the surface resistance. At nearly identical electrical resistances, the values for shielding in the E field vary greatly.

1. A magnetic additive and/or electrically conductive additive for compounding in a preferably thermosoft plastic in order to impart the plastic with properties for shielding against EMI radiation, characterized in that not only the electric field, but also the magnetic field is shielded.

2. A thermosoft plastic comprising a compounded filler, the thermosoft plastic having shielding behavior in the magnetic and in the electric field of greater than 20 dB each for objects made thereof or comprising the same and having a wall thickness between 1 and 4 mm, preferably 2 mm, characterized in that the compounded filler is a first magnetic additive or a mixture of a first and a second magnetic additive or a mixture of a magnetic additive and an electrically conductive additive.

3. The thermosoft plastic according to claim 2, characterized in that the first magnetic additive is selected from the group formed by:
diamagnets, semiconductors, paramagnets, ferromagnets, and ferrimagnets, wherein the group is particularly formed by
the diamagnets Cu, Cu alloys, particularly brass and bronzes, Cu powder coated with Ag,
the semiconductor CuO,
the paramagnets Al₂O₃, aluminum silicate, dolomite, MnSO₄,
the ferromagnet powdered iron,
the ferrimagnets iron ceramics and iron ores such as magnetite, ferrite, aluminoceladonite, powdered steel.

4. The thermosoft plastic according to claim 2 or 3, characterized in that the second magnetic additive is selected to be different from the first magnetic additive from the group according to claim 3.

5. The thermosoft plastic according to any one of the claims 2 through 4, characterized in that the magnetic additive has a particle size of D50 between 1 μm and 300 μm, wherein the particle size is selected particularly depending on the additive, and preferably
lies between 5 μm and 60 μm for ferrimagnetic additives, preferably between 10 μm and 53 μm, or between 200 μm and 400 μm, preferably between 250 μm and 325 μm
is less than 50 μm for ferromagnetic additives, particularly less than 45 μm,
is <10 μm for paramagnetic additives, particularly <5 μm,
is <20 μm for diamagnetic additives, particularly between 5 μm and 15 μm, very particularly preferably between 8 μm and 13 μm.

6. The thermosoft plastic according to claim 2 or 3, characterized in that the electrically conductive additive is selected from the group formed by carbon fibers, steel fibers, MWCNT, SWCNT, graphite, conductive carbon black, fullerenes, graphene.

7. The thermosoft plastic according to any one of the preceding claims, characterized in that the plastic selected is from the group formed by PA, PA6, PA66, PPS, PC, ABS, and copolymers of PC and ABS.

8. The thermosoft plastic according to claim 3, characterized in that the first and/or second magnetic additive is:
manganese sulfate having a weight proportion between 15 wt % and 25 wt %,
CuSn10 having undefined particle shape and a weight proportion of 0 wt % to 25 wt % and a D50 value of 64.4 μm, or
CuZn30 having undefined particle shape and a weight proportion of 0 wt % to 25 wt % and a D50 value of 240 mesh, or
copper(II) oxide having a weight proportion between 0 wt % and 50 wt %, preferably between 15 wt % and 45 wt %, and a D50 value of 23.9 μm, or
325 mesh powdered iron having a weight proportion between 15 wt % and 85 wt %, preferably between 55 wt % and 85 wt %, and a D50 value of ≤ 45 μm, or
gas-atomized ferritic powdered steel between 15 wt % and 85 wt %, preferably between 55 wt % and 85 wt %, and a D50 value of 20-60 μm, or
natural magnetite at a weight proportion between 15 wt % and 65 wt %, a D50 value of 17 μm, and preferably a particle density of 5.2 g/cm³, as well as a magnetite content of ≥98.1%, or
aluminum oxide at a weight proportion between 65 wt % and 75 wt % and a D50 value of 1.6 μm and an Al₂O₃ content >99.5%, or
anhydrous aluminum silicate treated with aminosilane, having 35 wt % to 45 wt % and a D50 value of 1.4 μm, wherein said material has an Al₂O₃ content from 42.1% to 44.3%, an SiO₂ content from 51.0% to 52.4%, and a TiO2 content from 1.56% to 2.5%, or
dolomite having a weight proportion between 35 wt % and 45 wt %, a D50 value between 2.4 μm and 3.0 μm, and a whiteness Ry≥93.5%.

9. The thermosoft plastic according to claim 4, characterized in that the first and the second magnetic additives are a combination of:
aluminum silicate and ferroaluminoceladonite, each having a weight proportion between 10 wt % and 20 wt %, a D50 value of 1.4 μm for aluminum silicate and 4.2 μm for the ferroaluminumceladonite.

10. The thermosoft plastic according to any one of the preceding claims, characterized in that said plastic comprises a PC-ABS in which a magnetic additive Ag—Cu-20 having a D50 value between 8 μm and 13 μm is compounded at a weight proportion of the entire plastic between 5 wt % and 10 wt %, and an MWCNT as the electrically conductive additive at 2 wt % to 5 wt %, particularly in the form of 13.3 wt % to 33.3 wt % of a mixture of PC and MWCNT under the trade name Plasticyl PC1501.

11. The thermosoft plastic according to claim 4, characterized in that the combination of electrically conductive additive and magnetic additive is the combination of the electrically conductive additive carbon fiber at a weight proportion between 10 wt % and 20 wt % and one of the following magnetic additives:
magnetite at a weight proportion between 35 wt % and 65 wt %, a particle density of 5.2 g/cm3, a magnetite content of ≥98.1% and a D50 value of 17 μm, or
325 mesh powdered iron at a weight proportion between 55 wt % and 65 wt % and a D50 value of ≤ 45 μm, or
gas-atomized ferritic powdered steel between 15 wt % and 85 wt %, preferably between 55 wt % and 85 wt %, and a D50 value of 20-60 μm
manganese zinc ferrite at a weight proportion between 35 wt % and 65 wt % and a D50 value of 250-315 μm.

12. The use of a thermosoft plastic according to claim 2 for achieving an X-ray detectability of an object produced therefrom.
